(19) United States
(12) Patent Application Publication
(10) Pub. No.: US 2026/0168971 A1
(43) Pub. Date: Jun. 18, 2026

(54) SYSTEMS AND METHODS FOR GAS CHROMATOGRAPHY AND CONTAMINATION DETECTION

(71) Applicant: Schlumberger Technology Corporation, Sugar Land, TX (US)

(72) Inventor: Matthias Francois, Clamart (FR)

(21) Appl. No.: 19/293,706

(22) Filed: Aug. 7, 2025

(30) Foreign Application Priority Data
Dec. 12, 2024 (EP) 24307095.0

(51) Int. Cl. G01N 30/88; E21B 49/08; G01N 30/02; G01N 30/86

(52) U.S. Cl. CPC G01N 30/88; E21B 49/086; G01N 30/8631; G01N 30/8665; G01N 2030/025

(57) ABSTRACT

Systems and methods for automated gas chromatography and contamination detection. The method comprising receiving a chromatograph of a gas sample, identifying, within a specified range of a calibration elution time of a target gas, a first candidate peak and a second candidate peak in the chromatograph, determining, based in part on a first elution time of the first candidate peak and the calibration elution time of the target gas, a first average elution error for the first candidate peak, determining, based in part on a second elution time of the second candidate peak and the calibration elution time of the target gas, a second average elution error for the second candidate peak, and determining that the first candidate peak corresponds to the target gas when the first average elution error is less than the second average elution error.

### CROSS REFERENCE TO RELATED APPLICATIONS

This application claims the benefit of EP Application Serial No. 24307095.0 entitled “SYSTEMS AND METHODS FOR GAS CHROMATOGRAPHY AND CONTAMINATION DETECTION” filed Dec. 12, 2024, the disclosure of which is incorporated herein by reference in its entirety.

### FIELD

The present disclosure relates to mud logging, and more specifically, to systems and methods for automated gas chromatography and contamination detection.

### BACKGROUND

In oil and gas exploration, mud logging refers to a process that involves generating data associated with a borehole being drilled into a subterranean formation. Mud logging may include, for example, analyzing and/or characterizing the drill bit cuttings (e.g., rock fragments) and gases that are liberated from the subterranean formation during the drilling process. With respect to the safety of the operators at the drilling site, it is important to know the amounts and/or the types of the gases being released during drilling as certain concentration of gases may be toxic to breathe and/or may result in blowout conditions. Moreover, knowledge of the types and/or amounts of gases being released during drilling can provide insight into the production potential of the subterranean formation underneath the drilling site. In that regard, accuracy when identifying and quantifying the gases released during drilling is invaluable.

Typically, tools such as gas chromatographs and/or mass spectrometers can be used to identify and/or quantify the different types of gases released from the subterranean formation during drilling. With respect to a gas chromatograph, in operation, a gas sample released during drilling can be injected into the inlet of the gas chromatograph. The sample is then heated such that different compounds (e.g., gas types) within the gas sample are eluted at different times. The respective elution times of the different compounds in the gas sample are then detected by a detector, which generates a signal that is used to generate and output a chromatograph.

A chromatograph is a visual representation of the different compounds in the bas sample as a series of peaks on a two-dimensional plot, where each peak in the chromatograph corresponds to a different compound present in the gas sample. The height (e.g., amplitude) of a peak indicates the relative abundance of a particular compound in the gas sample and the position on the x-axis of a peak (e.g., the elution time) represents how long it took for a particular compound in the gas sample to travel through the chromatography column and reach the detector.

In one conventional approach to labeling the peaks in a chromatograph with corresponding gases, the highest peak in the chromatograph is labelled as Cl gas (e.g., methane) by default. However, when used to analyze a chromatograph of a gas sample that was released from a subterranean formation during drilling, there are numerous factors that adversely affect the ability of this conventional approach to accurately detect and label the peaks in the chromatograph. For example, the peaks in the chromatograph may be shifted laterally along the x-axis due to one or more of variations in temperature and/or pressure of the gas sample during the drilling process, gases of interest being absent from the gas sample when the chromatograph is generated (e.g., as result of a degassing process prior to injection in the gas chromatograph), and/or contamination present within the gas sample. In that regard, by using the conventional approach in which the highest peak in chromatograph is labeled as C1 gas by default, C1 gas and the other gases (e.g., C2, C3, iC4, nC4, iC5, nC5, nC6, Benzene, nC7, etc.) in the gas sample are frequently mislabeled in the chromatograph. Notably, mislabeling the peaks in a chromatograph with incorrect gases results in inaccuracies in the identification and/or quantification of gases released from subterranean formation during drilling.

As the foregoing illustrates, what is needed in the art are more effective techniques for gas chromatography and contamination detection.

### SUMMARY

In one independent aspect, a method for automated gas chromatography. The method includes receiving a chromatograph of a gas sample, identifying, within a specified range of a calibration elution time of a target gas, a first candidate peak and a second candidate peak in the chromatograph, determining, based in part on a first elution time of the first candidate peak and the calibration elution time of the target gas, a first average elution error for the first candidate peak, determining, based in part on a second elution time of the second candidate peak and the calibration elution time of the target gas, a second average elution error for the second candidate peak, and responsive to determining that the first average elution error is less than the second average elution error, determining that the first candidate peak corresponds to the target gas.

In another independent aspect, a system for drilling a well in a subterranean formation. The system includes a drill string suspended at an upper end by a kelly and a traveling block, a drill bit attached to a lower end of the drill string, the drill bit adapted to rotate during drilling, a pump adapted pump drilling fluid through the drill string, a gas trap adapted to extract a gas sample from drilling fluid that was returned above a surface of the subterranean formation, the gas sample released from the subterranean formation during drilling, a gas chromatography device adapted to generate a chromatograph of the gas sample, and a computing device comprising one or more processors. The computing device is adapted to receive the chromatograph, identify, within a specified range of a calibration elution time of a target gas, a first candidate peak and a second candidate peak in the chromatograph, determine, based in part on a first elution time of the first candidate peak and the calibration elution time of the target gas, a first average elution error for the first candidate peak, determine, based in part on a second elution time of the second candidate peak and the calibration elution time of the target gas, a second average elution error for the second candidate peak, and determine that the first candidate peak corresponds to the target gas when the first average elution error is less than the second average elution error.

In another independent aspect, a mud logging unit comprising a display device and a processor coupled to the display device. The processor is adapted to receive a chromatograph of a gas sample, identify, within a specified range of a calibration elution time of a target gas, a first candidate peak and a second candidate peak in the chromatograph, determine, based in part on a first elution time of the first candidate peak and the calibration elution time of the target gas, a first average elution error for the first candidate peak, determine, based in part on a second elution time of the second candidate peak and the calibration elution time of the target gas, a second average elution error for the second candidate peak, determine that the first candidate peak corresponds to the target gas when the first average elution error is less than the second average elution error, and display, on the display device, the chromatograph.

Other aspects will become apparent by consideration of the detailed description and accompanying drawings.

At least one technical advantage of the disclosed techniques relative to conventional approaches is that target gas (e.g., C1 gas) peaks can be accurately detected within a chromatograph regardless of the presence of noise affecting the clarity of the chromatograph. At least another technical advantage of the disclosed techniques relative to conventional approaches is that, with the disclosed techniques, contamination in a gas sample released during drill can be detected based on a chromatograph of the gas sample.

### BRIEF DESCRIPTION OF THE DRAWINGS

FIG. 1 illustrates an example drilling system, according to aspects of the various embodiments.

FIG. 2 illustrates a close-up view of a drill bit and a lower end of a drill string included in the drilling system of FIG. 1, according to various embodiments.

FIG. 3 illustrates a block diagram of a mud logging unit implemented in conjunction with the drilling system of FIG. 1, according to various embodiments.

FIG. 4 is a block diagram of a computing device implemented in conjunction with the mud logging unit of FIG. 3, according to various embodiments.

FIGS. 5A and 5B illustrate example chromatography calibration data, according to various embodiments.

FIG. 6 is a flow diagram of method steps for automated gas chromatography, according to various embodiments.

FIG. 7 illustrates an example chromatograph of a gas sample released from a subterranean formation during a drilling process, according to various embodiments.

FIG. 8 illustrates an example window in the chromatograph of FIG. 7 that is within a range of the calibration elution time for C1 gas, according to the various embodiments.

FIGS. 9A and 9B illustrate example tables that list expected logging elution times for each additional gas in the chromatograph of FIG. 7, according to various embodiments.

FIGS. 10A and 10B illustrate example tables that list differences between expected logging elution times and elution times of matching peaks, according to various embodiments.

FIG. 11 illustrates an example parametric function that has been fitted to the peaks in a chromatograph, according to various embodiments.

FIG. 12 illustrates a comparison between the parametric function of FIG. 11 and a summation of the peaks included in the chromatograph of FIG. 11, according to various embodiments.

### DETAILED DESCRIPTION

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more electronic processors, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4.” The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

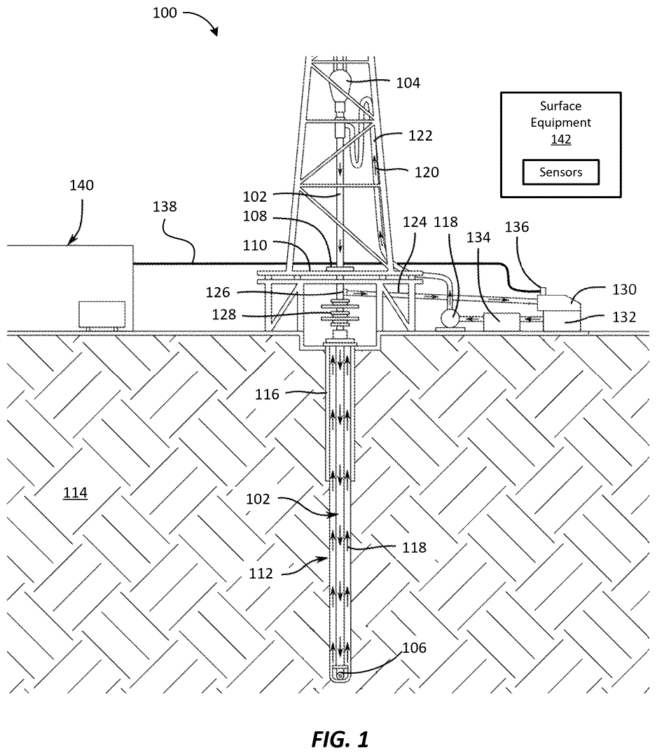

FIG. 1 illustrates an example drilling system 100, according to aspects of the various embodiments. The drilling system 100, which may hereinafter be referred to as a “rig,” is used, for example, to drill a well. As shown, the rig 100 includes a drill string 102 that is suspended at an upper end by a kelly and a traveling block 104 and terminated at a lower end by a drill bit 106. A rotary table 108 supported on a driller floor 110 is adapted to rotate the drill string 102 and the drill bit 106, thereby drilling a borehole 112 into a subterranean formation 114. In some examples, a portion of the borehole 112 is encased by a casing 116.

The rig 100 further includes a mud pump 118 that is adapted to pump drilling fluid, or “mud,” 120 into an upper end of the drill string 102 through a connecting mud line 122. From there, the mud 120 is pumped downward through the drill string 102 and exits the drill string 102 through an opening in the drill bit 106. Mud 120 that exits drill string 102 through an opening in the drill bit 106 is forced to return to the surface via an annulus formed between the borehole 112 and an outer diameter of the drill string 102. In the illustrated example of FIG. 1, mud 120 returning to the surface is represented using upward facing arrows. Once at the surface, the mud 120 flows into a return flow line 124 via a bell nipple 126. In some examples, the rig 100 includes a blowout preventer 128 positioned near the bell nipple 126. The blowout preventer 128 is adapted to prevent the occurrence of blowouts during a drilling operation.

During a drilling operation, drill bit cuttings are formed as the drill bit 106 rotates and crushes rocks within the subterranean formation 114. These drill bit cuttings are returned to the surface with the mud 120 that flows upward through the annulus formed between the borehole 112 and outer diameter of the drill string 102. To remove drill bit cuttings from the mud 120 such that the mud 120 can be reused for injection in the drilling operation, a shale shaker 130 is disposed along the return flow line 124. For example, the shale shaker 130 includes a shaker pit 132 that is adapted to remove the drill bit cuttings from the mud 120. Mud 120 then flows out of the shaker pit 132 into a mud pit 134 from which the mud pump 118 may draw the mud 120 to pump into the upper end of the drill string 102 through connecting mud line 122.

As further shown in FIG. 1, the shale shaker 130 includes and/or is coupled to a gas trap 136. During a drilling operation, gases are released from the subterranean formation 114 and returned to the surface in the mud 120. For example, similar to the drill bit cuttings formed during drilling, the gases released during drilling flow upward through the annulus formed between the borehole 112 and outer diameter of the drill string 102. As will be described in more detail herein, the gas trap 136 is adapted to extract these gases from the mud 120. The extracted gases are then transported via a gas line 138 to a mud logging unit 140 for analysis.

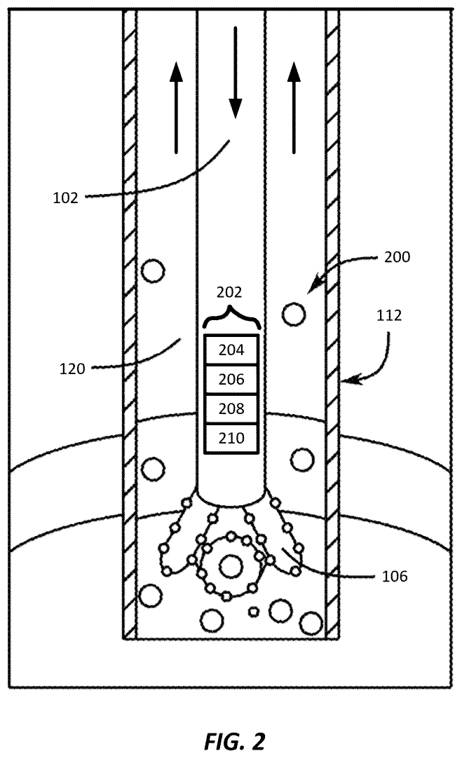

FIG. 2 illustrates a close-up view of the drill bit 106 and the lower end of the drill string 102 included in the rig 100, according to various embodiments. As shown in FIG. 2, drill bit cuttings 200 created by the drill bit 106 during a drilling operation flow upward towards the surface within the mud 120. For example, the mud 120 and drill bit cuttings 200 contained therein flow upward through the annulus formed between the wall of the borehole 112 and the outer diameter of the drill string 102.

As further shown in FIG. 2, the lower end of the drill string 102 comprises a drill string assembly 202. The drill string assembly 202 may be, for example, a bottom hole assembly (BHA). In some examples, the drill string assembly 202 is fitted with telemetry equipment 204. The telemetry equipment 204 can, for example, include one or more of a rotatable drive shaft, a turbine impeller mechanically coupled to the drive shaft such that the mud 120 can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud 120, and a controllable brake for selectively braking rotation of the modulator rotor to modulate pressure pulses. In some examples, an alternator may be coupled to the aforementioned drive shaft, the alternator including at least one stator winding electrically coupled to a control circuit to selectively short the at least one stator winding to electromagnetically brake the alternator and thereby selectively brake rotation of the modulator rotor to modulate the pressure pulses in the mud 120. In some examples, surface equipment 142 included in and/or coupled to the mud logging unit 140 includes circuitry adapted to sense pressure pulses generated by the telemetry equipment 204 and communicates the sensed pressure pulses to the mud logging unit 140.

As further shown in the illustrated example of FIG. 2, the drill string assembly 202 can include a logging-while-drilling (LWD) module 206, a measurement-while-drilling (MWD) module 208, and a rotary-steerable system (RSS) and/or motor 210. The drill bit 106, the LWD module 206, the MWD module 208, and/or the RSS 210 may be referred to as downhole tools of the drill string 102.

In some examples, the LWD module 206 is housed in a suitable type of drill collar and can contain one or more logging tools. In some examples, more than one LWD 206 can be included in the drill string assembly 202. In some examples, the LWD module 254 includes a seismic measuring device. The LWD module 206 can be adapted to measure, or log, one or more properties of the well being drilled in the subterranean formation 114. For example, the LWD module 206 generates well log data and/or well logs during a drilling operation. Well log data generated by the LWD module 206 can include, for example, geological data such as gamma ray log data, resistivity log data, density log data, sonic log data, and/or other types of log data. The LWD module 206 can then transmit the generated well log data and/or other information associated with the subterranean formation 114 to surface equipment 142 and/or the mud logging unit 140.

In some examples, the MWD module 208 is housed in a suitable type of drill collar and can contain one or more devices for measuring characteristics of the drill string 102 and/or the drill bit 106. In some examples, the MWD module 208 includes equipment for generating electrical power used to power various components of the drill string 102. In some examples, the MWD module 208 includes one or more measuring devices adapted to generated log data associated with the drill string 102 and/or the drill bit 106. For example, MWD module 208 includes one or more of a weight-on-bit measuring device, a rotation measuring device, a torque measuring device, a vibration measuring device, a shock measuring device, a stick slip measuring device, a direction measuring device, and an inclination measuring device. Log data generated by the one or more measuring devices included in the MWD module 208 can be transmitted by the MWD module 208 and/or the LWD module 206 to surface equipment 142 and/or the mud logging unit 140.

The RSS 210 includes equipment used for directional drilling. Directional drilling involves drilling into the subterranean formation 114 to form a deviated bore such that the trajectory of the bore is not vertical. Rather, the trajectory deviates from vertical along one or more portions of the bore. For example, consider a target that is located at a lateral distance from a surface location of the drill site 100. In such an example, drilling can commence with a vertical portion and then deviate from vertical such that the bore is aimed at the target and, eventually, reaches the target. In that regard, directional drilling can be implemented when a target is inaccessible from a vertical location at the surface above the subterranean formation 114, when material exists in the subterranean formation 114 that may impede drilling or otherwise be detrimental (e.g., consider a salt dome, etc.), when a formation is laterally extensive (e.g., consider a relatively thin yet laterally extensive reservoir), when multiple bores are to be drilled from a single surface bore, when a relief well is desired, and/or for some other reason.

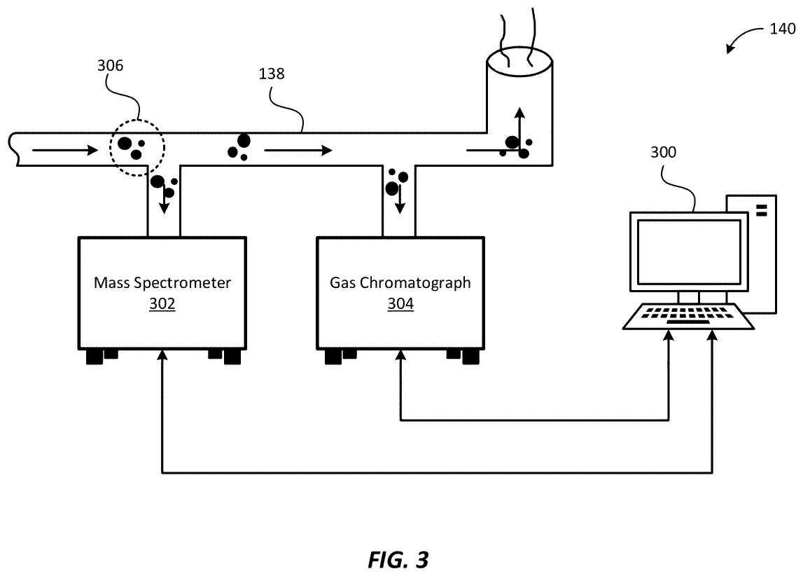

FIG. 3 illustrates a block diagram of the mud logging unit 140 implemented in conjunction with the rig 100 of FIG. 1, according to various embodiments. In the illustrated example of FIG. 3, the mud logging unit 140 includes a computing device 300 that is coupled to a mass spectrometer 302 and a gas chromatograph 304. In some examples, the computing device 300 is connected to the mass spectrometer 302 and/or the gas chromatograph 304 via one or more wired connections. In other examples, the computing device 300 is connected to the mass spectrometer 302 and/or the gas chromatograph 304 via one or more wireless (e.g., wireless network) connections.

In operation, gas particles, or gas samples, 306 that were released from the subterranean formation 114 during drilling and extracted from the mud 120 by the gas trap 136 are transported to the mud logging unit 140 via the gas line 138. As shown in the illustrated example of FIG. 3, a gas sample 306 flows through the gas line 138 to the mass spectrometer 302. In some examples, the mass spectrometer 302 is adapted to measure the mass of molecules included in the gas sample 306. In some examples, the mass spectrometer 302 is adapted to identify and/or quantify the chemicals and/or compounds included in the gas sample 306. In some examples, the mass spectrometer 302 outputs, or transmits, one or more measurements associated with the gas sample 306 to the computing device 300. In some examples, the mud logging unit 140 does not include a mass spectrometer 302.

As further shown in the illustrated example of FIG. 3, a gas sample 306 flows through the gas line 138 to the gas chromatograph 304. For example, a gas sample 306 can be injected into an inlet of the gas chromatograph 304, which is adapted to heat the gas sample 306 such that the different gases and/or compounds contained in the gas sample 306 (e.g., C1, C2, C3, iC4, nC4, iC5, nC5, nC6, Benzene, nC7, etc.) are eluted at different times. The gas chromatograph 304 then detects (e.g., via a detector) and generates a chromatograph that indicates the respective abundances and elution times of the different gases and/or compounds in the sample. As will be described in more detail herein, in some examples, the gas chromatograph 304 transmits the generated chromatographs to the computing device 300 for further analysis. In other examples, the gas chromatograph 304 is adapted to perform the chromatograph analysis described herein with respect to the computing device 300.

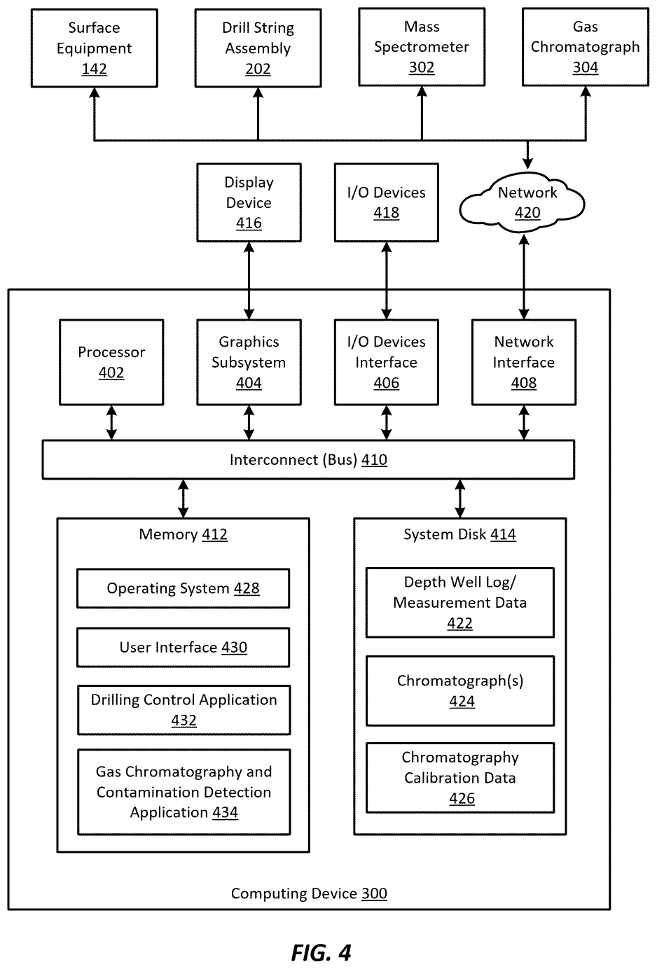

FIG. 4 is a block diagram of the computing device 300 implemented in conjunction with the mud logging unit 140 of FIG. 3, according to various embodiments. The computing device 300 can be implemented as, for example, a smartphone, a tablet, a laptop, a desktop computer, a server and/or any other suitable computing device. Persons skilled in the art will understand that the computing device 300 shown in FIG. 4 provides just one non-limiting example architecture that can be used to implement the computing device 300 included in the mud logging unit 140. Moreover, other suitable computing devices not described herein may be used to implement the computing device 300. In some examples, the computing device 300 is located onsite at the rig 100. In other examples, the computing device 300 is located offsite at a remote location.

As shown in FIG. 4, the computing device 300 can include, without limitation, a processor 402, a graphics subsystem 404, an I/O devices interface 406, a network interface 408, an interconnect 410, a memory subsystem 412, and a system disk 414. The interconnect, or bus, 410 can include one or more wires, cables, traces, contacts, analog components, digital components, wireless connection components, and/or other suitable means for interconnecting hardware components of the computing device 300.

In some embodiments, the processor 402 (e.g., a CPU or similar processor) is adapted to retrieve and execute programming instructions stored in the memory subsystem 412. Similarly, the processor 402 is adapted to store and retrieve application data (e.g., software libraries) residing in the memory subsystem 412 and/or the system disk 414. The interconnect 410 is adapted to facilitate transmission of data, such as programming instructions and application data, between the processor 402, the graphics subsystem 404, the I/O devices interface 406, the network interface 408, the memory subsystem 412, and the system disk 414.

In some embodiments, the graphics subsystem 404 is adapted to generate frames of image and/or video data and transmit the frames of image and/or video data to display device 416. In some embodiments, the graphics subsystem 404 may be integrated into an integrated circuit, along with the processor 402. The display device 416 may comprise any technically feasible means for generating an image for display. For example, the display device 416 may be fabricated using liquid crystal display (LCD) technology, cathode-ray technology, and light-emitting diode (LED) display technology. The display device 416 may include, for example, one or more monitors.

The input/output (I/O) devices interface 406 is adapted to receive input data from user I/O devices 418 and transmit the input data to the processor 402 via the interconnect 410. For example, user I/O devices 418 may comprise one or more buttons, a touchscreen, a keyboard, and a mouse or other pointing device. The I/O devices interface 406 also includes an audio output unit adapted to generate an electrical audio output signal. User I/O devices 418 may comprise one or more speakers adapted to generate an acoustic output in response to the electrical audio output signal. In alternative embodiments, the display device 416 may include the speaker.

In some examples, the I/O devices interface 406 can be connected to one or more modules of the surface equipment 142, one or more modules of the drill string assembly 202 (e.g., the telemetry equipment 204, the LWD module 206, the MWD module 208, and/or the RSS 210), the mass spectrometer 302, and/or the gas chromatograph 304. In some examples, the computing device 300 can receive, via the I/O devices interface 406, well log data and/or other measurements generated by the LWD module 206 and/or the MWD module 208. In some examples, the computing device 300 can transmit, via the I/O devices interface 406, commands for controlling drilling to the telemetry equipment 204 and/or the RSS 210. In some examples, the computing device 300 can receive, via the I/O devices interface 406, one or more measurements from the mass spectrometer 302. In some examples, the computing device 300 can receive, via the I/O devices interface 406, one or more measurements and/or chromatographs from the gas chromatograph 304.

The network interface 408 is adapted to transmit and receive packets of data via one or more network connections 420. In some examples, the network interface 408 is adapted to receive, via one or more network connections 420, well log data and/or other measurement data from one or more of the LWD module 206, the MWD module 208, and/or the surface equipment 142. In some examples, the network interface 408 is adapted to transmit, via one or more network connections 420, one or more signals for controlling drilling to the telemetry equipment 204 and/or the RSS 210. In some examples, the network interface 408 is adapted to receive, via one or more network connections 406, one or more measurements from the mass spectrometer 302. In some examples, the network interface 408 is adapted to receive, via one or more network connections 406, one or more measurements and/or chromatographs from the gas chromatograph 304. In some examples, the network interface 408 is adapted to communicate, via one or more network connections 420, with one or more external computing devices.

The one or more network connections 420 can be established, for example, via one or more of a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.). In other examples, the one or more network connections 420 are established using a local area network (LAN), a neighborhood area network (NAN), a home area network (HAN), and/or a personal area network (PAN) employing any of a variety of communications protocols, such as Wi-Fi, Bluetooth, ZigBee, etc. In some examples, the one or more network connections 420 are established using one or more of a wide area network (WAN), a local area network (LAN), a neighborhood area network (NAN), a home area network (HAN), or personal area network (PAN). In some examples, the one or more network connections 420 are established using wired connections.

The system disk 414, such as a hard disk drive or flash memory storage drive, is adapted to store non-volatile data. For example, the system disk 414 stores one or more files, applications, and/or programs to be implemented by the processor 402. In some examples, the system disk 414 stores well log data and/or other measurement data 422. For example, the system disk 414 stores one or more gamma ray depth well logs, one or more formation strength depth well logs, and/or other types of well logs comprising well log data and/or other measurement data generated by the LWD module 206, the MWD module 208, and/or one or more other sensors. In some examples, the system disk 414 can also store one or more chromatographs 424 generated by the gas chromatograph 304 and/or chromatography calibration data 426.

As will be described in more detail herein, chromatography calibration data 426 can include chromatographs and associated data of gas samples extracted from the mud 120 by the gas trap 136 during a calibration phase. During a calibration phase, temperature and/or pressure conditions associated with the gas samples released from the subterranean formation 114 during drill are stable. Moreover, in the calibration phase, there are little to no contaminants present with within the gas samples released from the subterranean formation 114 during drilling. In that regard, peaks are easy to detect in the chromatographs generated from gas samples collected during the calibration phase. In some examples, chromatography calibration data 426 is provided by a third-party contractor. In other examples, operators of the rig 100 use the mud logging unit 140 to generate the chromatography calibration data 426.

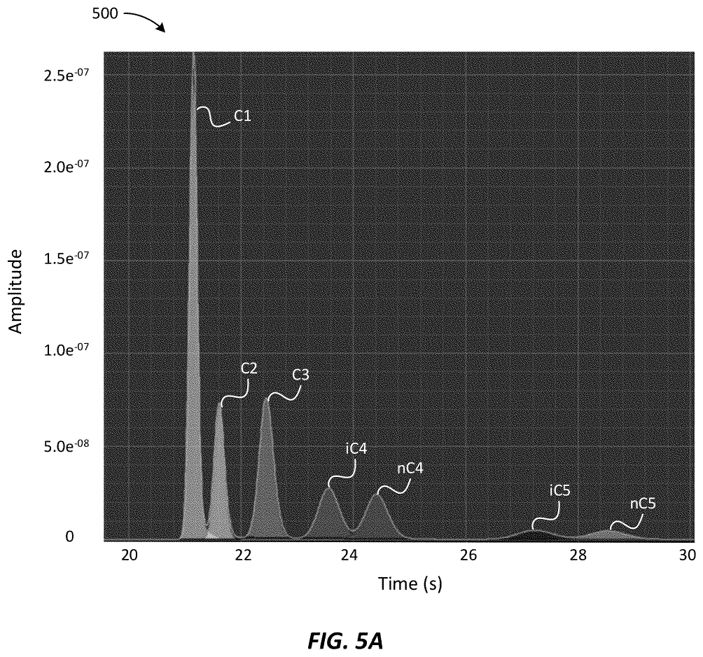

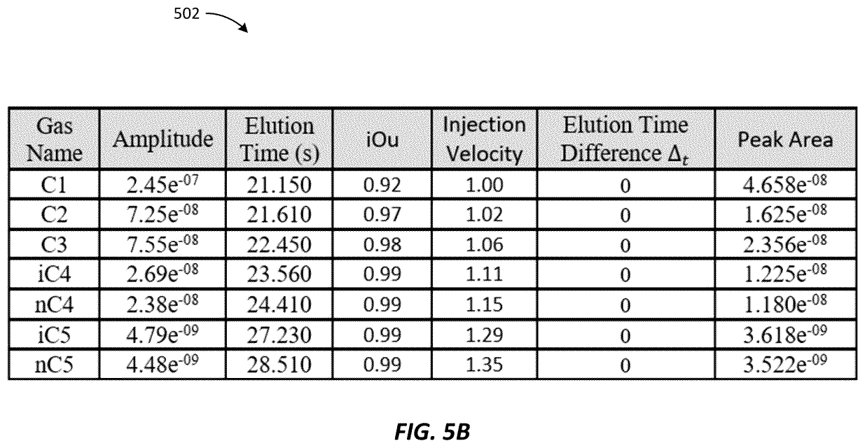

FIGS. 5A and 5B illustrate example chromatography calibration data, according to various embodiments. For example, FIG. 5A illustrates an example calibration chromatograph 500 and FIG. 5B illustrates a calibration data table 502 that corresponds to the calibration chromatograph 500. The chromatograph 500 was, for example, generated by the gas chromatograph 304 during a calibration phase in which temperature and/or pressure conditions associated with gas samples released from the subterranean formation 114 during drilling were stable and no contamination was present in the gas samples.

As shown in FIG. 5A, the peak in the calibration chromatograph 500 that has the highest amplitude (e.g., 2.45e-07) and corresponds to the shortest elution time (e.g., 21.150 seconds) is labeled as C1 gas (e.g., methane). The remaining peaks detected in the calibration chromatograph 500 are labeled in sequential order according to their elution times. For example, the peak corresponding to the second shortest elution time (e.g., 21.610 seconds) is labeled as C2 gas (e.g., ethane), the peak corresponding to the third shortest elution time (e.g., 22.450 seconds) is labeled as C3 gas (e.g., propane), the peak corresponding to the fourth shortest elution time (e.g., 23.560 seconds) is labeled as iC4 gas (e.g., isobutane), the peak corresponding to the fifth shortest elution time (e.g., 24.410 seconds) is labeled as nC4 gas (e.g., normal butane), the peak corresponding to the sixth shortest elution time (e.g., 27.230 seconds) is labeled as iC5 gas (e.g., isopentane), the peak corresponding to the seventh shortest elution time (e.g., 28.510 seconds) is labeled as nC5 gas (e.g., normal pentane).

As shown in FIG. 5B, the calibration data table 502 includes additional data associated with each of the peaks detected in the calibration chromatograph 500. For example, the calibration data table 502 includes the respective amplitudes, elution times, intersection over union (iOu) values, injection velocities, elution time differences, and peak areas for each peak in the calibration chromatograph 500. Notably, the elution time differences are all zero in the calibration data table 502. However, as will be described in more detail herein, elution time difference is a metric that can be used to compare peaks in chromatographs 424 generated by the gas chromatograph 304 to chromatography calibration data 426.

In some examples, the memory subsystem 412 includes programming instructions and application data that comprise an operating system 428, a user interface 430, a drilling control application 432, and a gas chromatograph and contamination detection (GCCD) application 434. The operating system 428 performs system management functions such as managing hardware devices including graphics subsystem 404, I/O devices interface 406, the network interface 408, and system disk 414. The operating system 428 also provides process and memory management models for the user interface 430, the drilling control application 432, and/or the GCCD application 434. The user interface 430, such as a window and object metaphor, provides a mechanism for user interaction with computing device 300. Persons skilled in the art will recognize the various operating systems and user interfaces that are well-known in the art and suitable for incorporation into the computing device 300.

When executed by the processor 402, the drilling control application 432 can be used to control one or more parameters of a drilling operation. For example, the drilling control application 432 can be used to control the telemetry equipment 204 and/or the RSS 210 to perform a drilling operation as described herein. In some examples, the drilling control application 432 uses well log data and/or other measurement data generated by the LWD module 206 and/or the MWD module 208 to control a drilling operation. In some examples, the drilling control application 432 uses chromatographs and/or chromatography data generated by the gas chromatograph 304 and/or the GCCD application 434 to control a drilling operation. In some examples, the drilling control application 432 provides an interface through which an operator at the rig 100 can interact with the drilling control application 432 to control a drilling operation. For example, the drilling control application 432 enables an operator at the rig 100 to input one or more command for controlling a drilling operation via the I/O devices 418.

As described herein, the gas chromatograph 304 is adapted to generate chromatographs of gas samples released from the subterranean formation 114 during drilling. When executed by the processor 402, the GCCD application 434 uses one or more techniques to analyze chromatographs 424 generated by the gas chromatograph 304. In some examples, analyzing a chromatograph 424 includes identifying and/or quantifying gases released during drilling based on the peaks included in the chromatograph 424. For example, the GCCD application 434 can detect and associate the peaks in a chromatograph with corresponding gas types (e.g., C1, C2, C3, iC4, nC4, iC5, nC5, nC6, Benzene, nC7, etc.). In some examples, analyzing a chromatograph includes detecting contamination in a gas sample released from the subterranean formation 114 based in part on the peaks in a chromatograph 424. For example, the GCCD application 434 can determine that contamination is present within a gas sample when peaks in a chromatograph 424 deviate from chromatography calibration data 426 by more than a threshold amount.

As described herein, with conventional approaches to analyzing chromatographs, the first peak in a chromatograph is typically labeled as C1 gas by default. However, oftentimes, the first peak appearing in a chromatograph does not correspond to C1 gas, and thus, peaks in a chromatograph are often mislabeled with incorrect gas types with conventional approaches. For example, a first peak in a chromatograph may correspond to noise that is attributed to contamination, changing pressure conditions, and/or changing pressure temperature conditions in the gas samples released during drilling. In such an example, the peak corresponding to noise gets labeled as C1 with the conventional approach, and subsequent peaks may also get mislabeled with incorrect gases (e.g., C2, C3, C4, etc.).

In that regard, when analyzing the peaks in a chromatograph 424, the GCCD application 434 does not default to labeling the first peak in the chromatograph 424 as C1. Rather, as will be described in more detail herein, the GCCD application 434 identifies C1 in the chromatograph 424 by detecting one or more candidate peaks within a range r of the elution time that corresponds to a calibration elution time of C1. For each candidate peak identified within the range r of the calibration elution time of C1, the GCCD application 434 determines a candidate elution error that is used for calculating a respective expected elution time for each of the other gases expected to be in the chromatograph. The GCCD application 434 then associates C1 with the candidate peak that results in the smallest combined error between expected elution times and the calibration elution times described in chromatography calibration data 426.

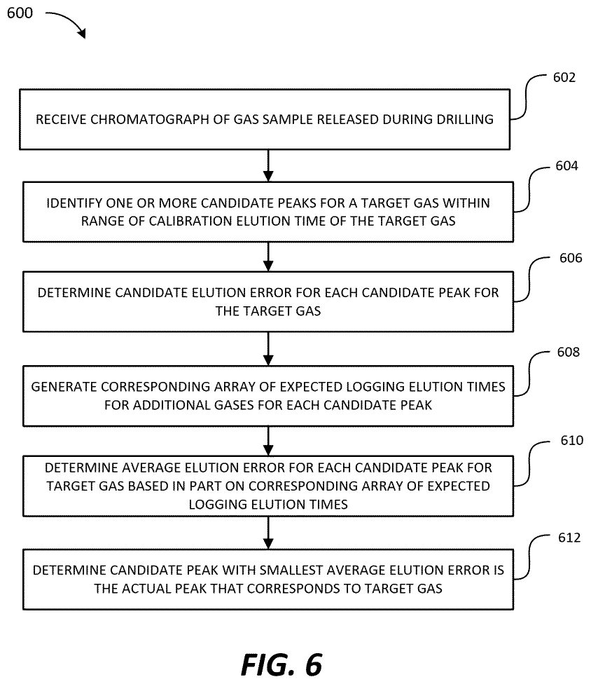

FIG. 6 is a flow diagram of method steps for automated gas chromatography, according to various embodiments. Although the method steps are described in conjunction with the systems of FIGS. 1-5 and 7-12, persons skilled in the art will understand that any system configured to perform the method steps, in any order, is within the scope of the present disclosure.

As shown, a method 600 begins at step 602, at which a chromatograph of a gas sample released during drilling is received. For example, the GCCD application 434 receives a chromatograph of a gas sample that was released from the subterranean formation 114 during drilling.

In some examples, chromatograph received at step 602 is generated by the gas chromatograph 304. In such examples, the gas trap 136 extracts a gas sample from the mud 120 and transports the extracted gas sample to the mud logging unit 140 via the gas line 138. Then, the gas sample is injected into an inlet of the gas chromatograph 304, which is adapted to heat the gas sample such that the different gases and/or compounds contained in the gas sample (e.g., C1, C2, C3, iC4, nC4, iC5, nC5, nC6, Benzene, nC7, etc.) are eluted at different times. The gas chromatograph 304 detects (e.g., via a detector) and generates a chromatograph that indicates the respective abundances and elution times of the different gases and/or compounds in the sample. The GCCD application 434 then receives the chromatograph from the gas chromatograph 304.

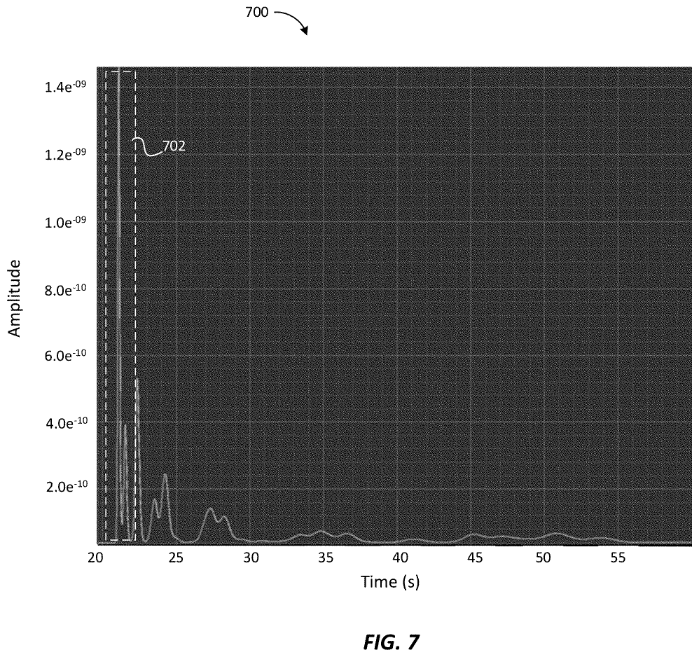

FIG. 7 illustrates an example chromatograph 700 of a gas sample released from a subterranean formation during a drilling process, according to various embodiments. The chromatograph 700 was generated, for example, by the gas chromatograph 304 based on a gas sample that was released from the subterranean formation 114 during a drilling process. In some examples, the chromatograph 700 is received by the GCCD application 434 at step 602 of the method 600.

At step 604, one or more candidate peaks for a target gas are identified in the chromatograph received at step 602. For example, the GCCD application 434 identifies one or more peaks in the chromatograph 700 that are candidates for C1 gas.

In some examples, identifying one or more candidate peaks for C1 gas includes analyzing a window of the chromatograph that is within a range r of a calibration elution time associated with C1 gas. The calibration elution time associated with C1 gas, which can hereinafter be denoted as “tC1,” refers to the elution time of C1 that was determined during a calibration phase and stored as chromatography calibration data 426. In such examples, any peaks detected by the GCCD application 434 to be within the range r of tC1 can be considered candidate peaks for C1 gas. In some examples, the value of r is a predetermined value. In some examples, the value of r is a configurable value that can be adjusted by an operator of the mud logging unit 140. In some examples, the value of r is determined based in part on chromatography calibration data 426 and/or the number of peaks detected in the chromatograph received at step 602.

With respect to the illustrated example of FIG. 7, the GCCD application 434 analyzes a window 702 of the chromatograph 700 that is within a range r of tC1 to identify one or more candidate peaks for C1 gas. In the illustrated example of FIG. 7, tC1 has a value of 21.15 seconds. However, in other examples, tC1 has a different value. Furthermore, in the illustrated example of FIG. 1, the value of r is one second. Thus, in the illustrated example of FIG. 7, the window 702 is centered at 21.15 seconds and spans from 20.15 seconds to 22.15 seconds.

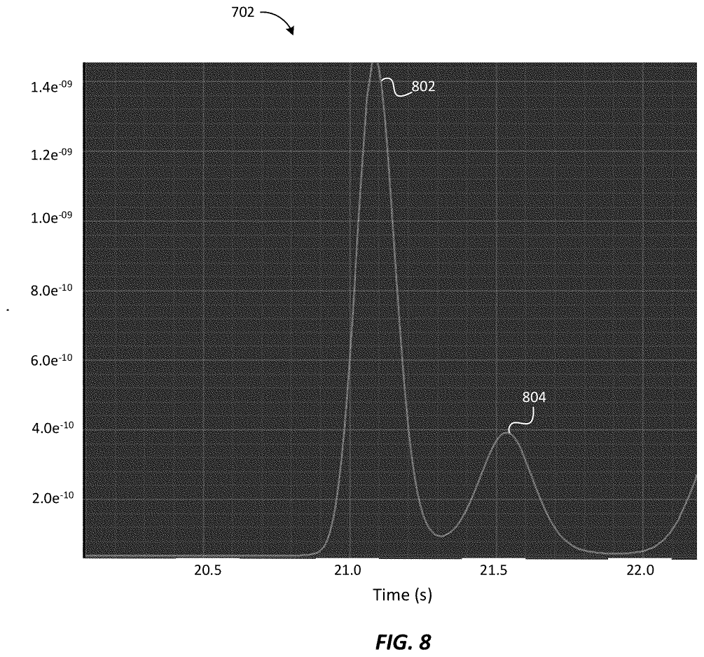

FIG. 8 illustrates an example window in the chromatograph of FIG. 7 that is within a range of the calibration elution time for C1 gas, according to various embodiments. For example, FIG. 8 illustrates the window 702 of chromatograph 700 that is within the range r (e.g., 1 second) of tC1 (e.g., 21.15 seconds). The GCCD application 434 analyzes the window 702 to identify one or more candidate peaks for C1 within the window 702. In the illustrated example of FIG. 8, the GCCD application 434 detects first and second candidate peaks 802, 804 within the window 702. In that regard, the GCCD application 434 identifies the first and second candidate peaks 802, 804 as candidate peaks for C1 gas at step 604 of the method 600.

In the illustrated example of FIG. 8, the elution time of the first candidate peak 802 is 21.09 seconds and the elution time of the second candidate peak 804 is 21.53 seconds. The elution times of the first and second candidate peaks 802, 804 may hereinafter be referred to as expected logging elution times, as the chromatograph 700 was generated during a logging (e.g., mud logging) phase and not a calibration phase. Although only two candidate peaks are identified in the illustrated example of FIG. 8, persons skilled in the art should understand that in other examples, fewer than two or more than two candidate peaks can be identified.

In some examples, at step 604, the GCCD application 434 does not detect any candidate peaks for C1 gas within a range r of tC1. In such examples, the GCCD application 434 can create artificial candidate peaks for C1 gas within the range r of tC1. Creating an artificial candidate peak for C1 gas includes selecting an expected logging elution time for the artificial candidate peak that is within the range r of tC1. In some examples, the GCCD application 434 selects one or more times within the range r of tC1 at random to create artificial candidate peaks for C1 gas. In some examples, the GCCD application 434 selects one or more of

$$\{ {t}_{C 1}^{cal} - r , {t}_{C 1}^{cal} - \frac{r}{2} , {t}_{C 1}^{cal} , {t}_{C 1}^{cal} + \frac{r}{2} , {t}_{C 1}^{cal} + r \}$$

expected logging elution times for one or more artificial candidate peaks for C1 gas. In some examples, the GCCD application 434 creates one or more artificial candidate peaks for C1 gas even if the GCCD application 434 identifies one or more candidate peaks for C1 gas at step 604. For example, the GCCD application 434 can generate one or more artificial candidate peaks for C1 gas if less than a threshold amount (e.g., 2, 3, 4, etc.) of candidate peaks for C1 gas are identified at step 602.

At step 606 in the method 600, a candidate elution error is determined for each identified candidate peak for the target gas. In some examples, the GCCD application 434 determines the candidate elution error for a candidate peak for C1 gas as a ratio between the expected logging elution time of the candidate peak for C1 gas and tC1. For example, Equation 1 below denotes an equation for determining the candidate elution error CEE for a candidate peak for C1 gas.

$${C}_{EE} = \frac{{t}_{C 1}^{log}}{{t}_{C 1}^{cal}} \qquad Equation 1$$

In the illustrated examples of FIGS. 7 and 8, the GCCD application 434 uses Equation 1 to determine that the candidate elution error for the first candidate peak 802 is approximately 0.997. Moreover, the GCCD application 434 uses Equation 1 to determine that the candidate elution error for the second candidate peak 804 is approximately 1.018.

At step 608 in the method 600, an array of expected logging elution times for the additional gases (e.g., C2, C3, iC4, nC4, etc.) in the chromatograph is generated for each respective candidate peak for the target gas. That is, a first array of expected logging elution times that corresponds to a first candidate peak for the C1 gas is generated, a second array of expected logging elution times that corresponds to a second candidate peak for the C1 gas is generated, and so on. In some examples, an array of expected logging elution times that corresponds to a respective candidate peak for the C1 gas is determined based in part on (i) the candidate elution error CEE of that respective candidate peak for the C1 gas and (ii) the calibration elution times for the additional gases included in the chromatograph. The calibration times for additional gases in the chromatograph can be obtained from the chromatography calibration data 426.

With respect to the illustrated examples of FIGS. 7 and 8, the GCCD application 434 can generate a first array of expected logging elution times that corresponds to the first candidate peak 802 based on (i) the candidate elution error CEE for the first candidate peak 802 and (ii) the calibration elution times for the additional gases in the chromatograph 700. Similarly, the GCCD application 434 can generate a second array of expected logging elution times that corresponds to the second candidate peak 804 based on (i) the candidate elution error CEE for the second candidate peak 804 and (ii) the calibration elution times for the additional gases in the chromatograph 700.

In some examples, the GCCD application 434 determines an expected logging elution time for a respective additional gas by multiplying the calibration elution time for the respective additional gas by a candidate elution error CEE of a candidate peak for the C1 gas. For example, Equation 2 below denotes a formula for determining an expected logging elution time

$${t}_{gas}^{log}$$

for an additional gas in the chromatograph, where CEE is determined using Equation 1 above and

$${t}_{gas}^{cal}$$

is the respective calibration elution time for the additional gas. As described herein, the value of

$${t}_{gas}^{cal}$$

can be obtained from chromatography calibration data 426.

$${t}_{gas}^{log} = E * {t}_{gas}^{cal} \qquad Equation 2$$

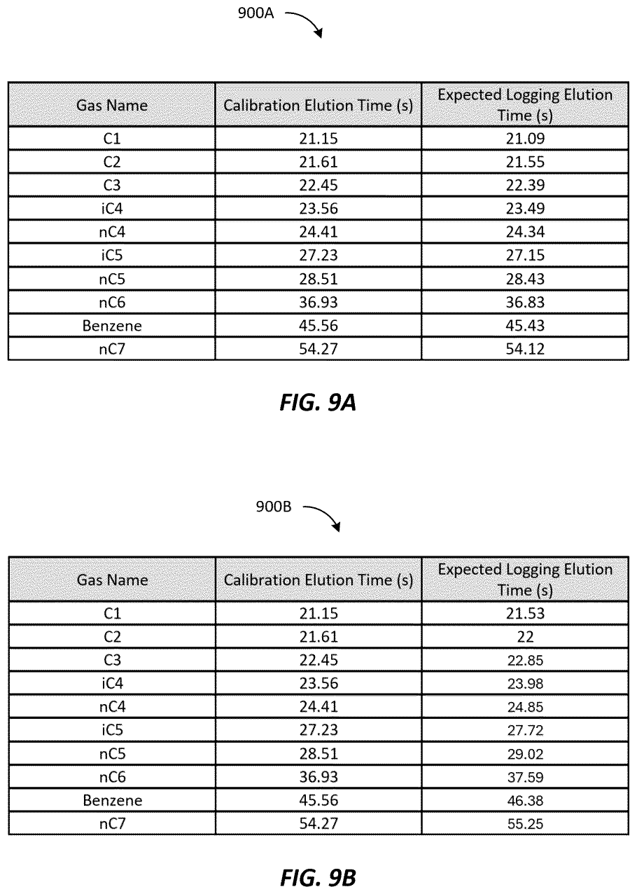

For example, the GCCD application 434 can determine the respective values of the expected logging elution times included in the first array that corresponds to the first candidate peak 802 by multiplying each calibration elution time for an additional gas by the candidate elution error CEE of the first candidate peak 802 (e.g., 0.997). FIG. 9A illustrates a table 900A that lists expected logging elution times for each additional gas in the chromatograph 700, according to various embodiments. Each expected logging elution time for an additional gas (e.g., C2, C3, iC4, nC4, iC5, nC5, nC6, Benzene, and nC7) listed in the table 900A was calculated, for example, by the GCCD application 434 using Equation 2, the candidate elution error CEE of the first candidate peak 802 (e.g., 0.997), and a corresponding calibration elution time. For example, the expected logging elution time for the C2 gas (e.g., 21.55 seconds) listed in table 900A was determined using Equation 2, the value of CEE determined for the first candidate peak 802 (e.g., 0.997), and the calibration elution time for the C2 gas (e.g., 21.61 seconds). As another example, the expected logging elution time for the C3 gas (e.g., 22.39 seconds) listed in table 900A was determined using Equation 2, the value of CEE determined for the first candidate peak 802 (e.g., 0.997), and the calibration elution time for the C3 gas (e.g., 22.45 seconds).

Similarly, the GCCD application 434 can determine the respective values of the expected logging elution times included in the second array that corresponds to the second candidate peak 804 by multiplying each calibration elution time for an additional gas by the candidate elution error CEE of the second candidate peak 804 (e.g., 1.018). FIG. 9B illustrates a table 900B that lists expected logging elution times for each additional gas in the chromatograph 700, according to various embodiments. Each expected logging elution time for an additional gas (e.g., C2, C3, iC4, nC4, iC5, nC5, nC6, Benzene, and nC7) listed in the table 900B was calculated, for example, by the GCCD application 434 using Equation 2, the candidate elution error CEE of the second candidate peak 804 (e.g., 1.018), and a corresponding calibration elution time. For example, the expected logging elution time for the C2 gas (e.g., 22 seconds) listed in the table 900B was determined using Equation 2, the value of CEE determined for the second candidate peak 804 (e.g., 1.018), and the calibration elution time for the C2 gas (e.g., 21.61 seconds). As another example, the expected logging elution time for the C3 gas (e.g., 22.85 seconds) listed in the table 900B was determined using Equation 2, the value of CEE determined for the second candidate peak 804 (e.g., 1.018), and the calibration elution time for the C3 gas (e.g., 22.45 seconds).

At step 610 of the method 600, a respective average elution error E_{Δ}_{ₜ} is determined for each candidate peak for the target gas. In some example, an average elution error E_{Δ}_{ₜ} for a particular candidate peak for the C1 gas can be determined, based in part, on the array of expected logging elution times that corresponds to the particular candidate peak for the C1 gas. In some examples, the GCCD application 434 determines the average elution error E_{Δ}_{ₜ} for each candidate peak for the C1 gas that was identified at step 604.

In some examples, determining an average elution error E_{Δ}_{ₜ} for a candidate peak for the C1 gas includes (i) matching each expected logging elution time in the array corresponding to the candidate peak with a respective peak detected in the chromatograph received at step 602, (ii) determining a difference between each expected logging elution time in the array and the elution time of the respective peak that was matched to that expected logging elution time, and (iii) averaging the determined differences between expected logging elution times in the array and the corresponding elution times of the matched peaks.

When determining an average elution error E_{Δ}_{ₜ} for the first candidate peak 802, the GCCD application 434 can match expected logging elution times included in the first array to peaks detected in the chromatograph 700 in a left-to-right sequential order. For example, the GCCD application 434 can match the expected logging elution time for the C2 gas to the next peak detected in the chromatograph 700 after the first candidate peak 802 when moving left to right from the first candidate peak 802. With reference to FIG. 7, since the first candidate peak 802 was selected to be the peak in the chromatograph 700 that has an elution time of 21.09 seconds, the GCCD application 434 matches the expected logging elution time for the C2 gas to the peak detected in the chromatograph 700 that has an elution time of 21.53 seconds (e.g., the next peak to the right of the first candidate peak 802).

Similarly, the GCCD application 434 can match the expected logging elution time for the C3 gas to the next peak in the chromatograph 700 that is detected after the peak having the elution time of 21.53 seconds. In that regard, the GCCD application 434 matches the expected logging elution time for the C3 gas to the peak detected in the chromatograph 700 that has an elution time of 22.34 seconds. The GCCD application 434 repeats the left-to-right matching process until each expected logging elution time in the first array is matched with a corresponding peak or until there are no more peaks detected in the chromatograph 700.

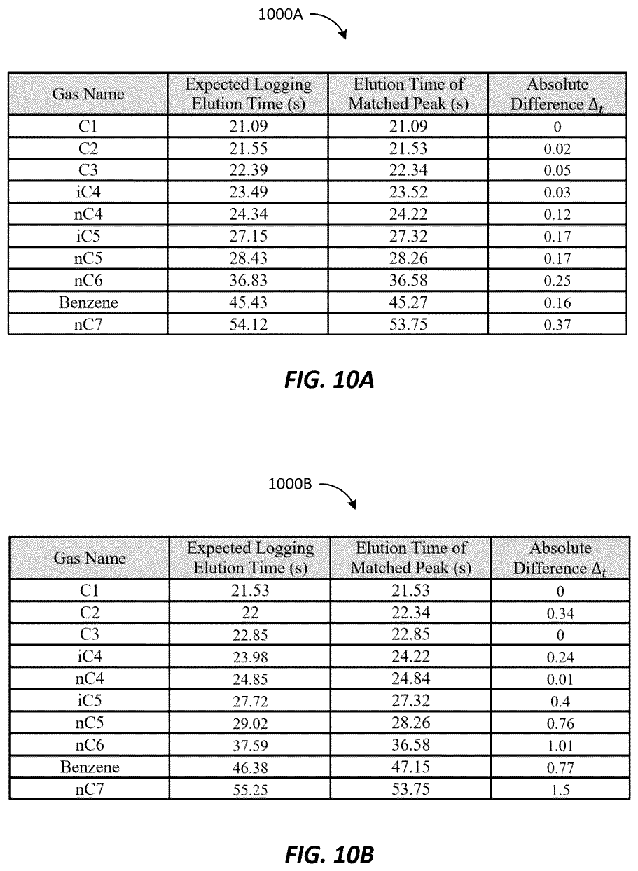

After matching the expected logging elution times in the first array to corresponding peaks detected in the chromatograph 700, the GCCD application 434 determines an absolute difference between each expected logging elution time in the first array and the respective elution time of the matching peak. For example, the GCCD application 434 determines an absolute difference between the expected logging elution time for the C2 gas (e.g., 21.55 seconds) and the elution time of the peak that was matched to the expected logging elution time for the C2 gas (e.g., 21.53 seconds). In this example, the absolute difference is 0.02. As another example, the GCCD application 434 determines an absolute difference between the expected logging elution time for the C3 gas (e.g., 22.39 seconds) and the elution time of the peak that was matched to the expected logging elution time for the C3 gas (e.g., 22.34 seconds). In this example, the absolute difference is 0.05. FIG. 10A illustrates a table 1000A that lists the differences between expected logging elution times included in the first array and the elution times of matching peaks.

After determining the absolute difference between each expected logging elution time included in the first array and the respective elution time of the matching peak, the GCCD application 434 determines the average elution error E_{Δ}_{ₜ} of the first candidate peak 802 to be an average of the determined absolute differences. For example, the GCCD application 434 uses Equation 3 below to determine the average elution error E_{Δ}_{ₜ} of the first candidate peak 802 based on the absolute differences listed in the table 1000A. In this example, the GCCD application 434 determines that the average elution error E_{Δ}_{ₜ} of the first candidate peak 802 is 0.134.

$${t}_{gas}^{log} = E * {t}_{gas}^{cal} \qquad Equation 3$$

When determining an average elution error E_{Δ}_{ₜ} for the second candidate peak 804, the GCCD application 434 can match expected logging elution times included in the second array to peaks detected in the chromatograph 700 in a left-to-right sequential order. For example, the GCCD application 434 can match the expected logging elution time for the C2 gas to the next peak detected in the chromatograph 700 after the second candidate peak 804 when moving left to right from the second candidate peak 804. With reference to FIG. 7, since the second candidate peak 804 was selected to be the peak in the chromatograph 700 that has an elution time of 21.53 seconds, the GCCD application 434 matches the expected logging elution time for the C2 gas to the peak detected in the chromatograph 700 that has an elution time of 22.34 seconds (e.g., the next peak to the right of second candidate peak 804).

Similarly, the GCCD application 434 can match the expected logging elution time for the C3 gas to the next peak in the chromatograph 700 that is detected after the peak having the elution time of 22.34 seconds. In that regard, the GCCD application 434 matches the expected logging elution time for the C3 gas to the peak detected in the chromatograph 700 that has an elution time of 22.85 seconds. The GCCD application 434 repeats the left-to-right matching process until each expected logging elution time in the first array is matched with a corresponding peak or until there are no more peaks detected in the chromatograph 700.

After matching the expected logging elution times in the second array to corresponding peaks detected in the chromatograph 700, the GCCD application 434 determines an absolute difference between each expected logging elution time in the first array and the respective elution time of the peak that was matched to the expected logging elution time. For example, the GCCD application 434 determines an absolute difference between the expected logging elution time for the C2 gas (e.g., 22.00 seconds) and the elution time of the peak that was matched to the expected logging elution time for the C2 gas (e.g., 22.34 seconds). In this example, the absolute difference is 0.34. As another example, the GCCD application 434 determines an absolute difference between the expected logging elution time for the C3 gas (e.g., 22.85 seconds) and the elution time of the peak that was matched to the expected logging elution time for the C3 gas (e.g., 22.85 seconds). In this example, the absolute difference is 0.00. FIG. 10B illustrates a table 1000B that lists the differences between the expected logging elution times included in the second array and the elution times of the matching peaks.

After determining the absolute difference between each expected logging elution time included in the second array and the respective elution time of the matching peak, the GCCD application 434 determines the average elution error E_{Δ}_{ₜ} of the second candidate peak 804 to be an average of the determined absolute differences. For example, the GCCD application 434 uses Equation 3 above to determine the average elution error E_{Δ}_{ₜ} of the second candidate peak 804 based on the absolute differences listed in the table 1000B. In this example, the GCCD application 434 determines that the average elution error E_{Δ}_{ₜ} of the second candidate peak 804 is 0.503.

At step 612 of the method 600, the candidate peak for the target gas having the smallest average elution error E_{Δ}_{ₜ} is determined to be the actual peak in the chromatograph that corresponds to the target gas. For example, the GCCD application 434 determines that the first candidate peak 802 is the peak in the chromatograph 700 that corresponds to the C1 gas. In some examples, step 612 includes labeling the selected candidate peak for the C1 gas with the C1 label in the chromatograph 700.

In some examples, the method 600 further includes modifying a drilling parameter (e.g., rate of penetration, rotary speed, or weight on the drill bit) during drilling based in part on the determined actual peak for the C1 gas. In some examples, the method 600 further includes stopping drilling based in part on the determined actual peak for the C1 gas. In some examples, the method 600 further includes rendering and displaying, on the display device 416, a chromatograph in which the peaks detected in the chromatograph are labeled with corresponding gas names determined with method 600.

As described herein, in some examples, the GCCD application 434 can analyze the shapes of the peaks in a chromatograph 434 to determine whether contamination is present in a gas sample. For example, the GCCD application 434 can determine that contamination is present within a gas sample when peaks in a chromatograph 424 deviate from chromatography calibration data 426 by more than a threshold amount.

In one example, assuming that the shapes of the peaks for targeted gases (e.g., C1, C2, C3, etc.) in a chromatograph 434 remain relatively stable during the transition from calibration phase to logging phase, the GCCD application 434 can use a peak fitting parametric function to reconstruct, or model, each peak in the chromatograph 434. This peak fitting parametric function can include parameters related to peak width, peak height, peak amplitude, time shifting of the peak, and/or other parameters of the peaks in a chromatograph. In some examples, one or more parameters of the peak fitting parametric function, such as amplitude and time shifting, are dynamic whereas one or more other parameters remain constant.

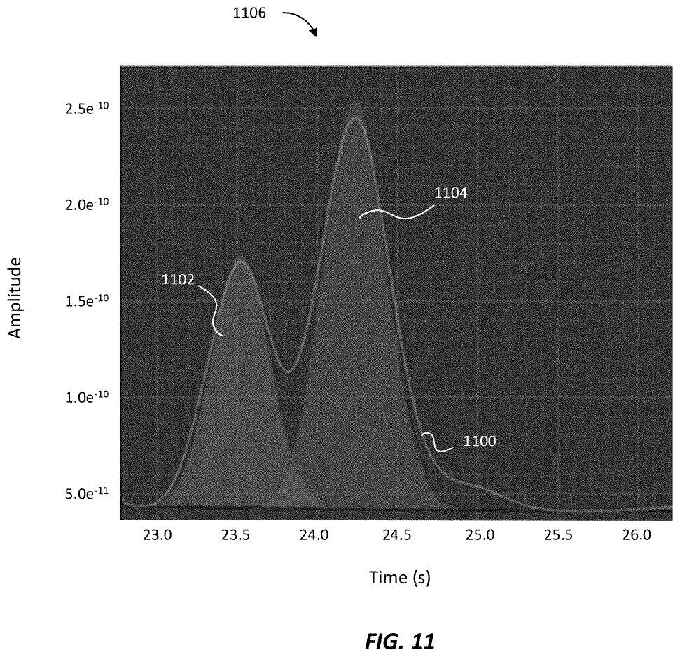

FIG. 11 illustrates an example parametric function that has been fitted to the peaks in a chromatograph, according to various embodiments. For example, FIG. 11 illustrates a parametric function 1100 that has been fitted to first and second peaks 1102, 1104 in a chromatograph 1106. In some examples, the GCCD application 434 generates and fits the parametric function 1100 to the first and second peaks 1102, 1104. As shown in FIG. 11, the parametric function 1100 is not a perfect fit as there is some overlap and/or crossover between the parametric function 1100 and the first and second peaks 1102, 1104.

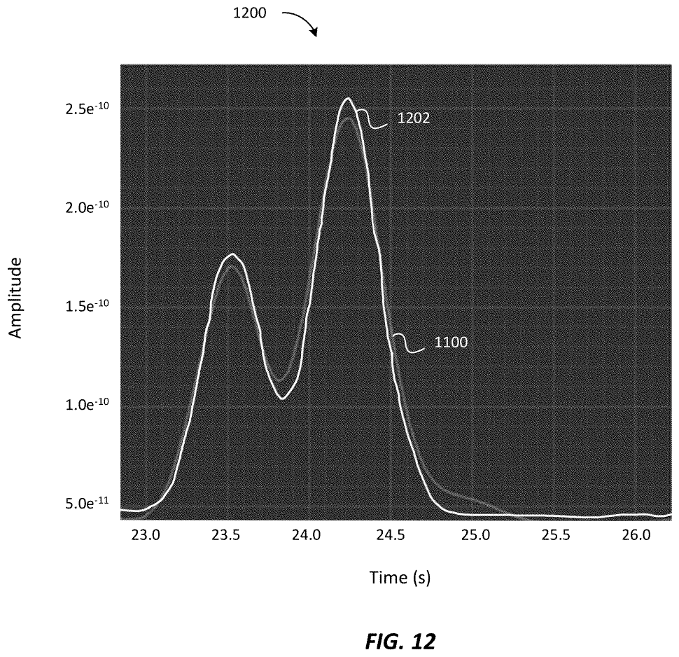

FIG. 12 illustrates a comparison between the parametric function of FIG. 11 and a summation of the peaks included in the chromatograph of FIG. 11, according to various embodiments. For example, FIG. 12 illustrates a graph 1200 that displays a comparison between the parametric function 1100 and the summation 1202 of the first and second peaks 1102, 1104 in the chromatograph 1106. In some examples, the GCCD application 434 can generate and display the graph 1200 on the display device 416.

In some examples, the GCCD application 434 can analyze the parametric function 1100 with respect to one or more of the first and second peaks 1102, 1104 to determine whether contamination is present and/or building up within the gas sample. For example, the GCCD application 434 can implement intersection over union “iOu” analysis by comparing the intersected area between the parametric function 1100 and the summation 1202 of the first and second peaks 1102, 1104 with the union area of the parametric function 1100 and the summation 1202 of the first and second peaks 1102, 1104.

In some examples, the GCCD application 434 uses Equation 4 below to determine the area of the intersection between the parametric function 1100 and one of the first peak 1102 or the second peak 1104.

$$\begin{matrix}{area}_{inter} ( peak ) = {\sum }_{i = {peak}_{start}}^{n = {peak}_{end}} min ( {y}_{summation} ( {t}_{i} ) , \\ {f}_{param} ( {t}_{i} ) )\end{matrix} \qquad Equation 4$$

Moreover, in some examples, the GCCD application 434 uses Equation 5 below to determine the area of the union between parametric function 1100 and one of the first peak 1102 or the second peak 1104.

$$\begin{matrix}{area}_{union} ( peak ) = {\sum }_{i = {peak}_{start}}^{n = {peak}_{end}} max ( {y}_{summation} ( {t}_{i} ) , \\ {f}_{param} ( {t}_{i} ) )\end{matrix} \qquad Equation 5$$

With the results of Equations 4 and 5, the GCCD application 434 can then use Equation 6 below to determine the iOu for a respective one of the first or second peaks 1102, 1104 and the parametric function 1100.

$$iou ( peak ) = \frac{{area}_{inter} ( peak )}{{area}_{over} ( peak )} \qquad Equation 6$$

Using Equations 4-6 with respect to the illustrated examples of FIGS. 11 and 12, the GCCD application 434 determines that the first peak 1102 has an iOu of 0.94 and the second peak 1104 has an iOu of 0.85. In general, the further the iOu value for a peak is from a value of 1.0, the more likely it is that the gas corresponding to that peak is contaminated. For example, the GCCD application 434 determines that the gas corresponding to the second peak 1104 is likely contaminated as the iOu value for the second peak 1104 differs from 1.0 by 0.15. Likewise, the GCCD application 434 determines that the gas corresponding to the first peak 1102 is unlikely to be contaminated as the iOu value for the first peak 1102 differs from 1.0 by only 0.06.

In some examples, the GCCD application 434 compares the iOu value for a given peak to a threshold to determine whether the gas corresponding to that given peak is contaminated. For example, the GCCD application 434 determines that a gas is contaminated when the iOu value for the peak corresponding to that gas is less than a threshold (e.g., 0.9, 0.85, 0.8, etc.). In some examples, the GCCD application 434 compares the iOu value for a given peak to a plurality of thresholds to gauge the severity and/or amount of contamination present in the gas that corresponds to the given peak. In some examples, in response to determining that a gas is contaminated, the GCCD application 434 generates an alert. Generating an alert can include displaying an alert on the display device 416, transmitting a message that contains the alert to one or more external computing devices, sounding an alarm, and/or some other action.

In some examples, in response to the GCCD application 434 determining that a gas is contaminated, the drilling control application 432 controls one or more components of the rig 100 to stop a drilling process. In some examples, in response to the GCCD application 434 determining that a gas is contaminated, the drilling control application 432 modifies a drilling parameter (e.g., rate of penetration, rotary speed, or weight on the drill bit) during drilling.

Any and all combinations of any of the claim elements recited in any of the claims and/or any elements described in this application, in any fashion, fall within the contemplated scope of the present disclosure and protection. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine.

The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for automated gas chromatography, the method comprising:
receiving a chromatograph of a gas sample;
identifying, within a specified range of a calibration elution time of a target gas, a first candidate peak and a second candidate peak in the chromatograph;
determining, based in part on a first elution time of the first candidate peak and the calibration elution time of the target gas, a first average elution error for the first candidate peak;
determining, based in part on a second elution time of the second candidate peak and the calibration elution time of the target gas, a second average elution error for the second candidate peak; and
responsive to determining that the first average elution error is less than the second average elution error, determining that the first candidate peak corresponds to the target gas.

2. The method of claim 1, further comprising:
extracting, by a gas trap, the gas sample from drilling fluid that is returned above a surface of a subterranean formation during a drilling process;
injecting the gas sample into an inlet of a gas chromatography device; and
generating, by the gas chromatography device, the chromatograph.

3. The method of claim 1, wherein determining the first average elution error includes:
determining, based in part on the first elution time and the calibration elution time, a first candidate elution error;
generating, based in part on the first candidate elution error and a first plurality of calibration elution times, a first array that includes a first plurality of expected elution times for additional gases in the gas sample; and
determining, based in part on the first array and one or more additional peaks detected in the chromatograph, the first average elution error.

4. The method of claim 3, wherein generating the first array includes multiplying each calibration elution time in the first plurality of calibration elution times by the first candidate elution error.

5. The method of claim 3, wherein determining the first average elution error further includes:
detecting the one or more additional peaks in the chromatograph;
matching each expected elution time included in the first array with a corresponding additional peak included in the one or more additional peaks;
determining a respective time difference between each expected elution time included in the first array and an elution time of the corresponding additional peak matched to that expected elution time; and
determining an average of a sum of each respective time difference.

6. The method of claim 1, wherein determining the second average elution error includes:
determining, based in part on the second elution time and the calibration elution time, a second candidate elution error;
generating, based in part on the second candidate elution error and a second plurality of calibration elution times, a second array that includes a second plurality of expected elution times for additional gases in the gas sample; and
determining, based in part on the second array and one or more additional peaks detected in the chromatograph, the second average elution error.

7. The method of claim 6, wherein generating the second array includes multiplying each calibration elution time in the second plurality of calibration elution times by the second candidate elution error.

8. The method of claim 6, wherein determining the second average elution error further includes:
detecting the one or more additional peaks in the chromatograph;
matching each expected elution time included in the second array with a corresponding additional peak included in the one or more additional peaks;
determining a respective time difference between each expected elution time included in the second array and an elution time of the corresponding additional peak matched to that expected elution time; and
determining an average of a sum of each respective time difference.

9. The method of claim 1, further comprising:
generating a parametric function that fits the first candidate peak in the chromatograph;
determining an area of intersection between the parametric function and the first candidate peak;
determining an area of union between the parametric function and the first candidate peak;
determining a ratio between the area of intersection and the area of union;
responsive to determining that the ratio is less than a threshold, generating an alert that indicates contamination is present in the target gas or stopping a drilling process.

10. The method of claim 1, further comprising:
generating an artificial candidate peak, the artificial candidate peak having an artificial elution time that is within the specified range of the calibration elution time of the target gas;
determining, based on the artificial elution time of the artificial candidate peak and the calibration elution time of the target gas, an artificial candidate elution error;
generating, based on the artificial candidate elution error and a third plurality of calibration elution times, an array that includes a plurality of expected elution times for additional gases in the gas sample; and
determining, based on the array and one or more additional peaks detected in the chromatograph, a third average elution error for the artificial candidate peak.

11. A system for drilling a well in a subterranean formation, comprising:
a drill string suspended at an upper end by a kelly and a traveling block;
a drill bit attached to a lower end of the drill string, the drill bit adapted to rotate during drilling;
a pump adapted pump drilling fluid through the drill string;
a gas trap adapted to extract a gas sample from drilling fluid that was returned above a surface of the subterranean formation, the gas sample released from the subterranean formation during drilling;
a gas chromatography device adapted to generate a chromatograph of the gas sample; and
a computing device comprising one or more processors, the computing device adapted to:
receive the chromatograph;
identify, within a specified range of a calibration elution time of a target gas, a first candidate peak and a second candidate peak in the chromatograph;
determine, based in part on a first elution time of the first candidate peak and the calibration elution time of the target gas, a first average elution error for the first candidate peak;
determine, based in part on a second elution time of the second candidate peak and the calibration elution time of the target gas, a second average elution error for the second candidate peak; and
determine that the first candidate peak corresponds to the target gas when the first average elution error is less than the second average elution error.

12. The system of claim 11, wherein to generate the first average elution error, the computing device is adapted to:
determine, based in part on the first elution time and the calibration elution time, a first candidate elution error;
generate, based in part on the first candidate elution error and a first plurality of calibration elution times, a first array that includes a first plurality of expected elution times for additional gases in the gas sample; and
determine, based in part on the first array and one or more additional peaks detected in the chromatograph, the first average elution error.

13. The system of claim 12, wherein to generate the first array, the computing device is adapted to multiply each calibration elution time included in the first plurality of calibration elution times by the first candidate elution error.

14. The system of claim 12, wherein to determine the first average elution error for the first candidate peak, the computing device is further adapted to:
detect the one or more additional peaks in the chromatograph;
match each expected elution time included in the first array with a corresponding additional peak included in the one or more additional peaks;
determine a respective time difference between each expected elution time included in the first array and an elution time of the corresponding additional peak matched to that expected elution time; and
determine an average of a sum of each respective time difference.

15. The system of claim 11, wherein to generate the second average elution error, the computing device is adapted to:
determine, based in part on the second elution time and the calibration elution time, a second candidate elution error;
generate, based in part on the second candidate elution error and a second plurality of calibration elution times, a second array that includes a second plurality of expected elution times for additional gases in the gas sample; and
determine, based in part on the second array and one or more additional peaks detected in the chromatograph, the second average elution error.

16. The system of claim 15, wherein to generate the second array, the computing device is adapted to multiply each calibration elution time included in the second plurality of calibration elution times by the second candidate elution error.

17. The system of claim 15, wherein to determine the second average elution error for the second candidate peak, the computing device is further adapted to:
detect the one or more additional peaks in the chromatograph;
match each expected elution time included in the second array with a corresponding additional peak included in the one or more additional peaks;
determine a respective time difference between each expected elution time included in the second array and an elution time of the corresponding additional peak matched to that expected elution time; and
determine an average of a sum of each respective time difference.

18. A mud logging unit, comprising:
a display device; and
a processor coupled to the display device, the processor adapted to:
receive a chromatograph of a gas sample;
identify, within a specified range of a calibration elution time of a target gas, a first candidate peak and a second candidate peak in the chromatograph;
determine, based in part on a first elution time of the first candidate peak and the calibration elution time of the target gas, a first average elution error for the first candidate peak;
determine, based in part on a second elution time of the second candidate peak and the calibration elution time of the target gas, a second average elution error for the second candidate peak;
determine that the first candidate peak corresponds to the target gas when the first average elution error is less than the second average elution error; and
display, on the display device, the chromatograph.

19. The mud logging unit of claim 18, wherein the processor is further adapted to:
generate a parametric function that fits the first candidate peak in the chromatograph;
determine an area of intersection between the parametric function and the first candidate peak;
determine an area of union between the parametric function and the first candidate peak;
determine a ratio between the area of intersection and the area of union;
generate an alert that indicates contamination is present in the target gas when the ratio is less than a threshold.

20. The mud logging unit of claim 18, wherein the processor is further adapted to:
generate an artificial candidate peak, the artificial candidate peak having an artificial elution time that is within the specified range of the calibration elution time of the target gas;
determine, based on the artificial elution time of the artificial candidate peak and the calibration elution time of the target gas, an artificial candidate elution error;
generate, based on the artificial candidate elution error and a third plurality of calibration elution times, an array that includes a plurality of expected elution times for additional gases in the gas sample; and
determine, based on the array and one or more additional peaks detected in the chromatograph, a third average elution error for the artificial candidate peak.
